(19) United States
(12) Patent Application Publication
(10) Pub. No.: US 2011/0063669 A1
(43) Pub. Date: Mar. 17, 2011

(54) PROGRAM, RECORDING MEDIUM, INFORMATION PROCESSING APPARATUS, AND INFORMATION PROCESSING SYSTEM

(75) Inventor: Jun KIMURA, Tokyo (JP)

(73) Assignee: RICOH COMPANY, LTD., Tokyo (JP)

(21) Appl. No.: 12/881,297

(22) Filed: Sep. 14, 2010

(30) Foreign Application Priority Data
Sep. 15, 2009 (JP) 2009-213755

(51) Int. Cl. G06F 3/12

(52) U.S. Cl. 358/1.15

(57) ABSTRACT

A disclosed information processing apparatus in which a printer driver for a plurality of printers is installed includes a change instructing unit instructing a port monitor, which outputs print data acquired from the printer driver to a preset output destination, to set a changed output destination, an identification information acquiring unit acquiring destination identification information which identifies the changed output destination when the port monitor is instructed to set the changed output destination, and a memory unit storing the output destination identification information and limit information indicative of a limit content of a printing function by associating the output destination identification information with the limit information, a search unit for searching the limit information corresponding to the changed output destination identification information in the memory unit; and an overwriting unit changing the limit information for the printer driver based on the corresponding limit information searched for by the search unit.

### BACKGROUND OF THE INVENTION

1. Field of the Invention

The present invention generally relates to a program, a recording medium, an information processing apparatus, and an information processing system.

2. Description of the Related Art

An example is given of changing users' conditions for printing settings and ordinary printing settings that are enabled to read the printing settings externally from a file using a printer driver to thereby limit freedom for a user of selecting printing settings in a printing setting screen.

Patent Document 1 discloses a technique in which a printer stores printing settings for each user and a driver acquires the printing settings from the printer with a bidirectional communications to revise the driver.

However, the above method of reading the printing settings can set up one limit for one printer driver. On the other hand, a so-called mobile printer driver can output data to plural printers using one printer driver. In this printer driver, it is not possible to change the limit setup for each printer if the printer does not have a measure of storing the limit information on the printer side.

Patent Document 1: Japanese Laid-Open Patent Application No. 2003-308187

### SUMMARY OF THE INVENTION

Accordingly, embodiments of the present invention provide a novel and useful program, recording medium, information processing apparatus, and information processing system which can carry out a limit setup of plural printers using one printer driver.

One aspect of the embodiments of the present invention may be to provide an information processing apparatus in which a printer driver for a plurality of printers is installed, the information processing apparatus including a change instructing unit configured to instruct a port monitor which outputs print data acquired from the printer driver to a preset output destination to set a changed output destination in place of the preset output destination, an identification information acquiring unit configured to acquire destination identification information which identifies the changed output destination when the port monitor is instructed by the change instructing unit to set the changed output destination, a memory unit configured to store the output destination identification information and the limit information indicative of a limit content of a printing function by associating the output destination identification information with the limit information, a search unit configured to search for the limit information corresponding to the changed output destination identification information acquired by the identification information acquiring unit from the memory unit, and an overwriting unit configured to change the limit information for the printer driver based on the corresponding limit information searched for by the search unit.

Additional objects and advantages of the embodiments will be set forth in part in the description which follows, and in part will be obvious from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a block chart illustrating examples of system structures and a hardware structure of the information processing system of Embodiment 1.

FIG. 2 is a block chart illustrating an example of a functional structure of the information processing apparatus of Embodiment 1.

FIG. 3 illustrates an example of an output destination changing screen of Embodiment 1.

FIG. 4 illustrates an example of a limit file of Embodiment 1.

FIG. 5 illustrates an example of a corresponding table of output destination identification information and limit file numbers.

FIG. 6A and FIG. 6B illustrate examples of transitions of a part of the printing setting screen.

FIG. 7 is a sequence diagram illustrating an example of an overwrite process for a limit file in Embodiment 1.

FIG. 8 is a sequence diagram illustrating an example of a display process in Embodiment 1.

FIG. 9 is a sequence diagram illustrating an example of another overwrite process for a limit file in Embodiment 1.

FIG. 10 is a block chart illustrating an example of an information processing system of Embodiment 2.

FIG. 11 is a block chart illustrating an example of functional structures of an information processing apparatus and a file server of Embodiment 2.

FIG. 12 is a sequence chart illustrating an example of an overwrite process in Embodiment 2.

### DETAILED DESCRIPTION OF THE PREFERRED EMBODIMENTS

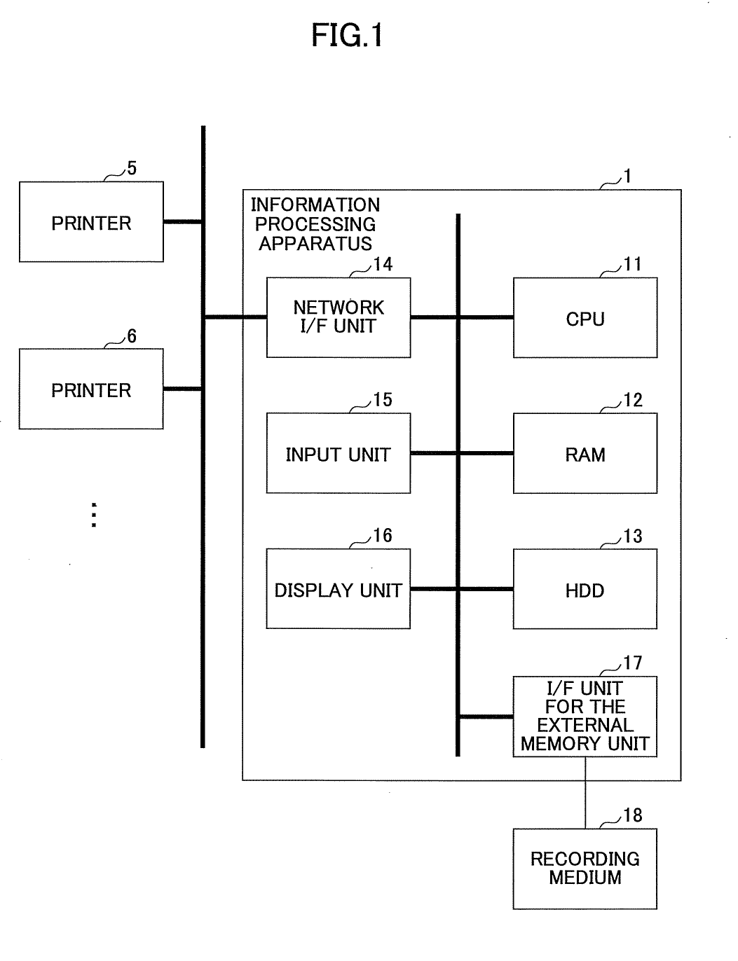

A description is given below, with reference to the FIG. 1 through FIG. 12 of embodiments of the present invention.

Hereinafter, reference symbols typically designate as follows:
1, 2: Information processing apparatus;
3: File server;
5, 6: Printer;
11: CPU;
12: RAM;
13: HDD;
14: Network I/F unit;
15: Input unit;
16: Display unit;
17: I/F unit for the external memory unit;
20: Printer driver;
21: Driver UI display unit;
22: Print unit;
23: Read unit;
24: Memory unit;
30, 60: Output destination changing application;
31: UI display unit;
32: Change instructing unit;
33: Identification information acquiring unit;
34, 73: Memory unit;
35, 72: Search unit;
36: Overwrite unit;
40: Port monitor;
50: Spooler;
61: Limit information acquiring unit; and
71: Communication unit.

### Embodiment 1

### <System Structure and Hardware Structure>

A system structure and a hardware structure of an information processing apparatus of Embodiment are described. FIG. 1 is a block chart illustrating examples of the system structure and the hardware structure of Embodiment 1.

As illustrated in FIG. 1, the image processing system of Embodiment includes an information processing apparatus 1, a printer 5, and a printer 6. The printers 5 and 6 print print data received from the information processing apparatus 1. The printer includes an image forming apparatus or the like.

The information processing apparatus 1 includes a central processing unit (CPU) 11, a random access memory (RAM) 12, a hard disk drive (HDD) 13, a network I/F unit 14, an input unit 15, a display unit 16, and an I/F unit 17 for an external memory unit.

The CPU 11 installed in a computer carries out control of various units and devices, and performs operations and processing of data. The CPU 11 is an operations unit which executes programs stored in the RAM 12, receives data from an input unit and a memory unit to operate on and process the data, and outputs the operated on and processed data to an output unit or the memory unit.

The RAM 12 is a memory unit which stores or temporarily stores a basic operation system (OS) for execution by the CPU 11, programs such as application software, and data.

The HDD 13 is a memory unit which stores data used for the application software or the like.

A network I/F unit 14 is an interface among the printers 5, 6 and the information processing apparatus 1 which have communication functions and are connected via a network such as an Ethernet (Ethernet is a registered trademark) via a local area network (LAN) and a wide area network (WAN), which may be constructed by wired or wireless data transmission lines.

The input unit 15 includes a keyboard having a cursor key, a numeric keypad, various function keys or the like, a mouse for enabling to select the keys on a display screen of a display unit 16, a slice pad or the like. The input unit 15 is a user interface through which the user can provide an operational instruction to the CPU 11 and input data.

The display unit 16 is made of a CRT, a LCD or the like and displays information in response to display data input from the CPU 11.

The I/F unit 17 for the external memory unit is an interface between a recording medium 18 such as a flash memory and the information processing apparatus 1 via a data communication line such as a universal serial bus (USB).

A predetermined program is stored in the recording medium 18. The predetermined program stored in the recording medium 18 is installed in the information processing apparatus 1 via the I/F unit 17 for the external memory unit, and the installed program can be executed by the information processing apparatus 1.

The information processing apparatus 1 may be a personal computer (PC). One information processing apparatus and two printers are connected in an example illustrated in FIG. 1. However, the numbers of the information processing apparatuses and printers are not so limited.

### <Functional Structure>

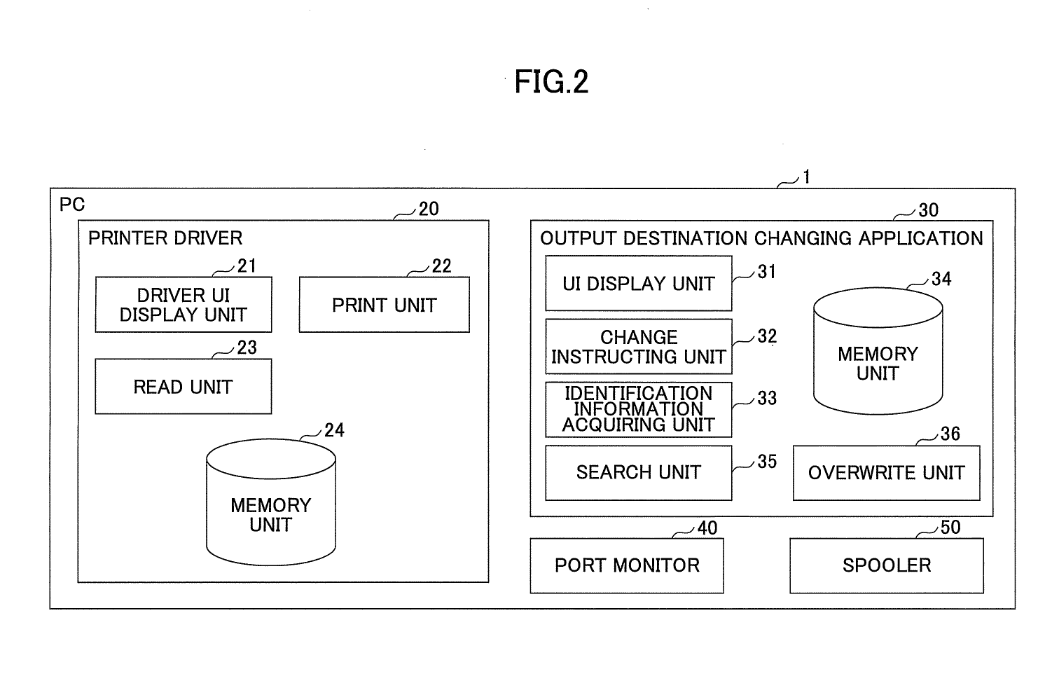

FIG. 2 is a block chart illustrating an example of a functional structure of the information processing apparatus of Embodiment 1. As illustrated in FIG. 2, the information processing apparatus 1 includes a printer driver 20, an output destination changing application 30, a port monitor 40 and a spooler 50.

The printer driver 20 transforms image information generated by an application to a page-description language which can be comprehended by the printers in printing image information generated by an application. The printer driver 20 outputs the transformed page-description language once to the spooler 50. The printer driver 20 can produce print data for plural printers without using another printer driver. An example of the above printer driver is a mobile printer driver which enables a user to print data sent from a mobile environment such as a notebook PC to an office printer.

Specifically, the printer driver 20 includes a driver UI display unit 21, a print unit 22, a read unit 23 and a memory unit 24. The driver UI display unit 21 displays a printing setting screen on the display unit 16 and receives printing settings from the users.

The print unit 22 transforms print data from the application to a page description language (PDL) and transmits the transformed page description language (PDL) to the printers 5 and 6.

The read unit 23 reads a limit file (limit information) stored in the memory unit 24, and reports a limit content when the driver UI display unit 21 displays the printing setting screen. The limit file is data indicative of the limit content of printing settings (print function). The memory unit 24 stores the limit file.

The output destination changing application (output destination changing unit) 30 transmits a report for changing an output destination set up in a port monitor 40 to the port monitor 40 upon receipt of an instruction from a user or the like.

The output destination changing application includes a UI display unit 31, a change instructing unit 32, an identification information acquiring unit 33, a memory unit 34, a search unit 35, and an overwrite unit 36. The UI display unit 31 displays an output destination changing screen for the user of selecting or inputting an output destination on a display unit 16 upon receiving an instruction from a user when the printer driver 20 is not activated.

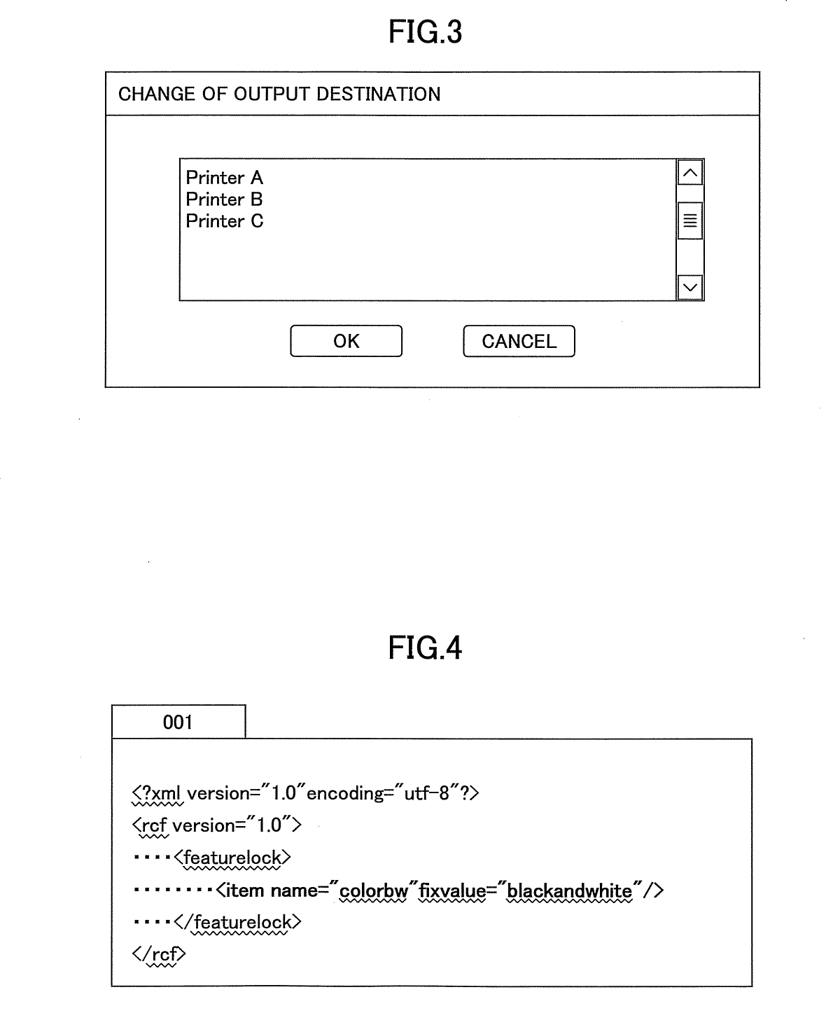

FIG. 3 illustrates an example of an output destination changing screen of Embodiment 1. As illustrated in FIG. 3, one of “printer A”, “printer B” and “printer C” is selected by the user. Further, the UI display unit 31 outputs identification information such as a printer ID indicative of a selected printer to the change instructing unit 32.

The user may search for the printer connected to the information processing apparatus 1 by directly inputting the address of the printer and select the printer from the search result.

Referring to FIG. 2, the change instructing unit 32 transmits a report of changing the output destination set up in the port monitor 40 to the port monitor 40 upon an instruction from a user. The transmitted report may be realized by an xcv command stipulated in Windows (Windows is a registered trademark). The xcv command makes it possible to change an output destination address (e.g. an IP address in TCP/IP) set up in the port monitor 40 to an output destination address which is newly selected or input by the user. The xcv command is used to change the output destination address from the outside of the information processing apparatus.

The change instructing unit 32 outputs an output destination address corresponding to the identification information of the output destination acquired from the UI display unit 31 to the port monitor 40 when the change instructing unit 32 receives a change instruction of the output destination from the user. The change instructing unit 32 holds information associating the identification information and the address of the output destination.

The identification information acquiring unit 33 acquires the output destination identification information for identifying the output destination from the output destination when the output destination is to be changed by instruction from the change instructing unit 32. The output destination identification information may be a printer name. The identification information acquiring unit 33 outputs the acquired output destination identification information to the search unit 35.

The printer name and the limit file are associated. The memory unit 34 stores plural combinations of the printer names and the limit files. Next, the limit file is described in detail. FIG. 4 illustrates an example of the limit file of Embodiment 1. Referring to FIG. 4, a limit file by which printing settings of color or black and white (B&W) are limited to B&W is described. The limit file has identification information for identifying the limit file. The identification information includes an identification number, an identification name or the like.

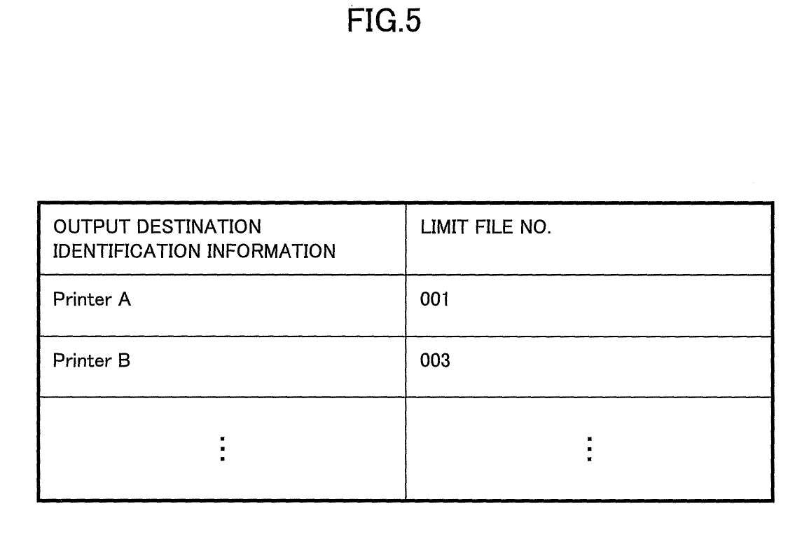

FIG. 5 illustrates a corresponding table between the output destination identification information stored in the memory unit 34 and a limit file No. As illustrated in FIG. 5, the limit file No. “001” is associated with output destination information “printer A”. The limit file may be directly associated with the output identification information.

Referring to FIG. 2, the search unit 35 searches for the limit file corresponding to the output destination identification information that is acquired by the identification information acquiring unit 33 in the memory unit 34 using the output destination identification information as a key. Then, the search unit 35 acquires a predetermined limit file which is previously set when the limit file corresponding to the output destination identification information as the key does not exist. The search unit 35 outputs the acquired limit file to the overwrite unit 36.

The overwrite unit 36 changes or overwrites the limit file stored in the memory unit 24 of the printer driver 20 using the limit file acquired from the search unit 35.

The printer driver 20 can display the printing setting screen in which printing is limited in conformity with the overwritten limit file when the printing setting screen is displayed. The above process is carried out every time when the output destinations are changed. Therefore, the printer driver 20 can display the printing setting screen in which printing is limited in correspondence with the printer currently set up in the port monitor 40.

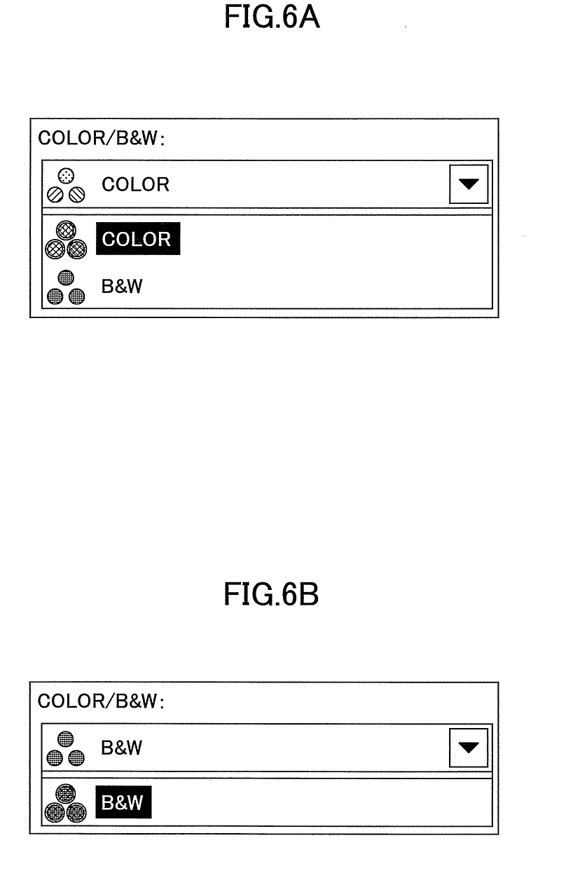

FIG. 6A and FIG. 6B illustrate examples of transitions of a part of the printing setting screen. FIG. 6A illustrates an example of selecting color or black and white (B&W) before overwriting the limit file. FIG. 6B illustrates an example of selecting color or B&W after overwriting the limit file. As illustrated in FIG. 6B, it is possible to select only the printing setting for B&W by overwriting the limit file.

Referring back to FIG. 2, the port monitor (output unit) outputs the page-description language output from the spooler 50 to a predetermined printer or an output destination via Ethernet (Ethernet is a registered trademark), a universal serial bus (USB) or the like. Further, the port monitor 40 may be specifically a standard TCP/IP port which is a port monitor for a network printer of Windows (Windows is a registered trademark.)

The spooler 50 has a memory area (i.e. a first memory unit) which temporarily stores printing jobs generated by the application to control the stored printing jobs to be sequentially output to the printer.

The IP address may be used as output destination identification information. The identification information acquiring unit 33 can acquire the IF address from the change instructing unit 32. Therefore, it is unnecessary for the identification information acquiring unit 33 to query the output destination as to the IP address. In this case, the memory unit 34 stores the IP address and the limit file while associating these.

### <Operations>

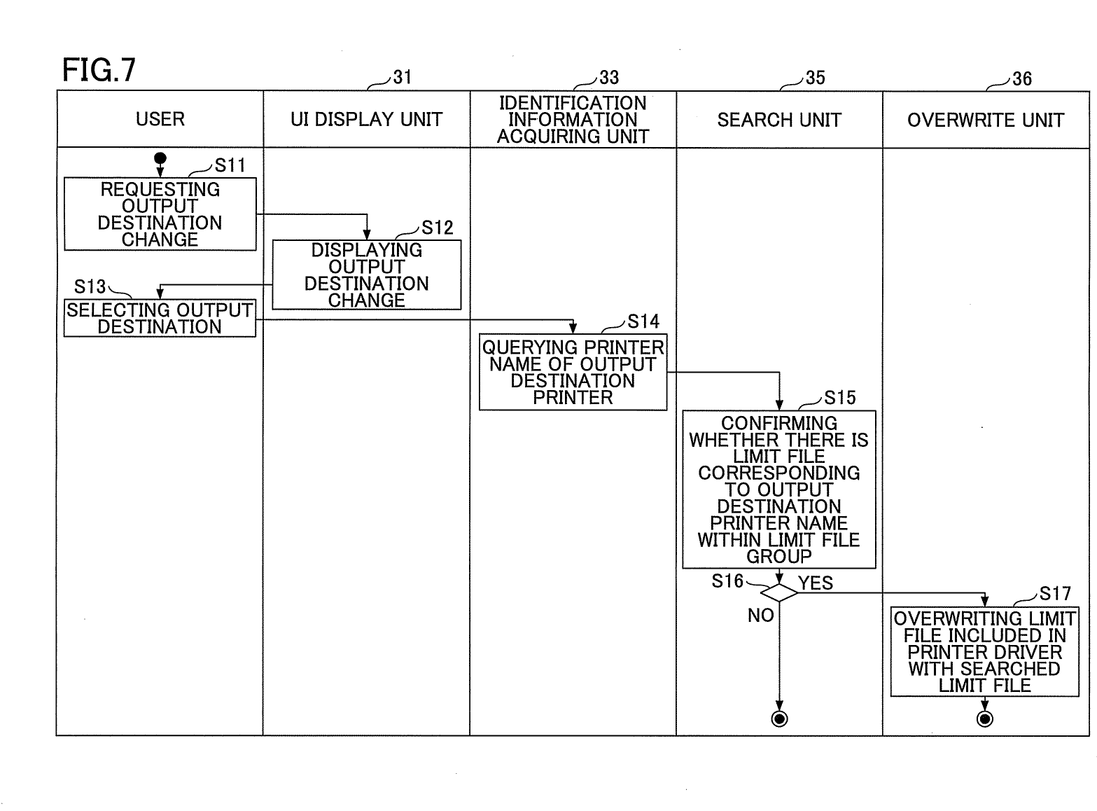

FIG. 7 is a sequence diagram illustrating an example of an overwrite process for a limit file in Embodiment 1. In step S11, the user may request to change the output destination by pushing an output destination changing button.

In step S12, the UI display unit 31 displays the output destination changing screen illustrated in FIG. 3 when in receipt of an instruction of changing the output destination.

In step S13, the user selects or inputs the output destination from the output destination changing screen illustrated in FIG. 3 to thereby instruct changing the output destination. Information indicative of the selected or input output destination is output to the change instructing unit 32.

In step S14, the identification information acquiring unit 33 acquires information of the output destination (e.g. IP address) from the change instructing unit 32 and queries the output destination printer as to the printer name. The identification information acquiring unit 33 outputs the acquired output destination identification information to the search unit 35.

In step S15, the search unit 35 searches to determine whether the limit file corresponding to the output destination printer name is stored in the memory unit 34.

In step S16, the search unit 35 proceeds to step S17 when there is a corresponding limit file, and ends the process if there is no corresponding limit file.

In step S17, the overwrite unit 36 changes the contents of the limit file stored in the printer driver 20 to those of the corresponding limit file.

As described above, every time when the output destination is changed the output destination changing application 30 can change the limit file of the printer driver 20.

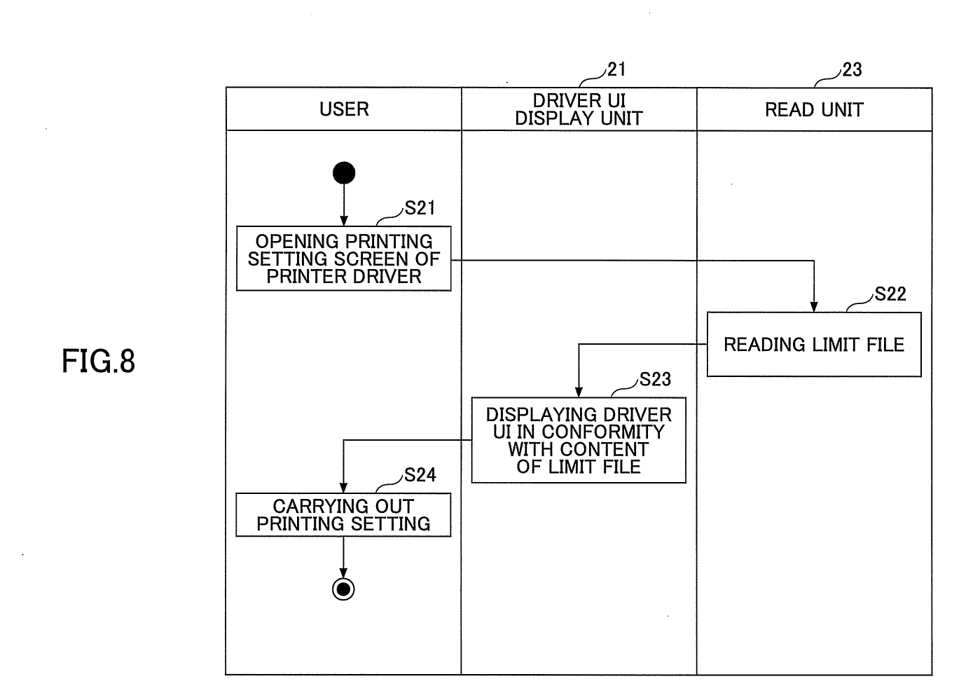

FIG. 8 is a sequence diagram illustrating an example of a display process of the printer driver 20 in Embodiment 1. In step S21, the user opens the printing setting screen of the printer driver 20. At this time, the driver UI display unit 21 instructs the read unit 23 to read the limit file.

In step S22, the read unit 23 receives the instruction from the driver UI display unit 21, reads the limit file from the memory unit 24, and outputs the read limit file to the driver UI display unit 21.

In step S23, the driver UI display unit 21 displays the printing setting screen in which the printing setting is limited by the read limit file on the display unit 16 in reference to FIG. 6B.

In step S24, the user carries out the printing settings via the printing setting screen in which the printing setting is limited. With this, the user cannot use functions and conditions of which the printing settings are limited.

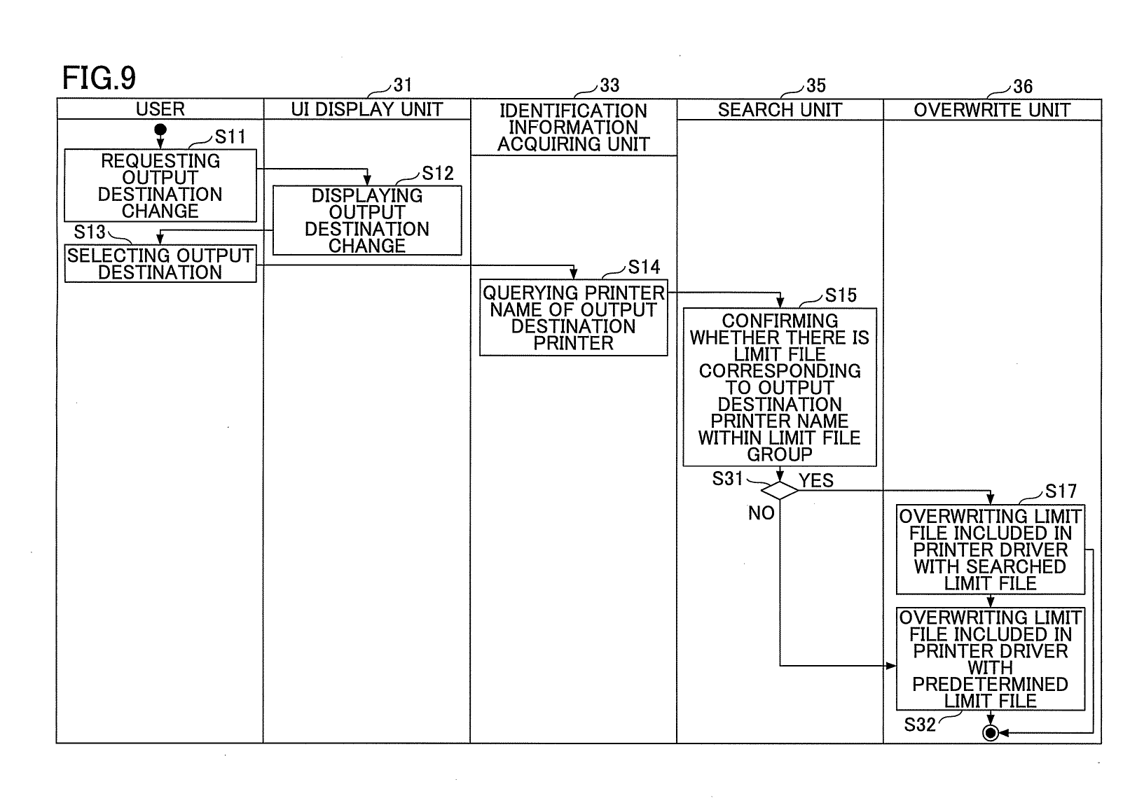

FIG. 9 is a sequence diagram illustrating an example of an overwrite process for the limit file in Embodiment 1. Referring to FIG. 9, the identical numerical references are used for processes similar to those in FIG. 7, and description of these processes is omitted.

In step S31, the search unit 35 proceeds to step S17 when there is a corresponding limit file, and proceeds to step S32 when there is no corresponding limit file. The search unit 35 reads the predetermined limit file from the memory unit 34 and outputs the predetermined limit file to the overwrite unit 36.

In step S32, the overwrite unit 36 reads the predetermined limit file and overwrites the limit file in the printer driver with the read limit file.

With this, even though the printer name of the output destination is not stored in the memory unit 34, it is possible to give a predetermined print limit to the printer driver 20.

As described, according to Embodiment 1, it is possible to carry out limit setups for plural printers using only one printer driver. According to Embodiment 1, it is possible to realize the above described process by installing an output destination changing application 30 without changing already used printers or printer drivers (software).

### Embodiment 2

Next, the information processing system of Embodiment 2 is described. In Embodiment 2, a memory unit which stores plural pairs of limit files and output destination identification information and a search unit are included in a file server 3.

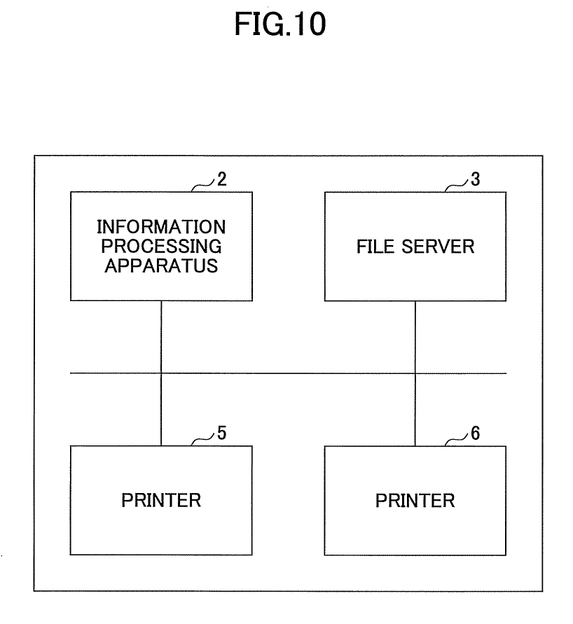

FIG. 10 is a block chart illustrating an example of an information processing system of Embodiment 2. Referring to FIG. 10, an image processing system includes an information processing apparatus 2, a file server 3, printers 5 and 6, and a network connecting these. Next, the information processing apparatus 2 and the file server 3 are described in detail.

### <Functional Structure>

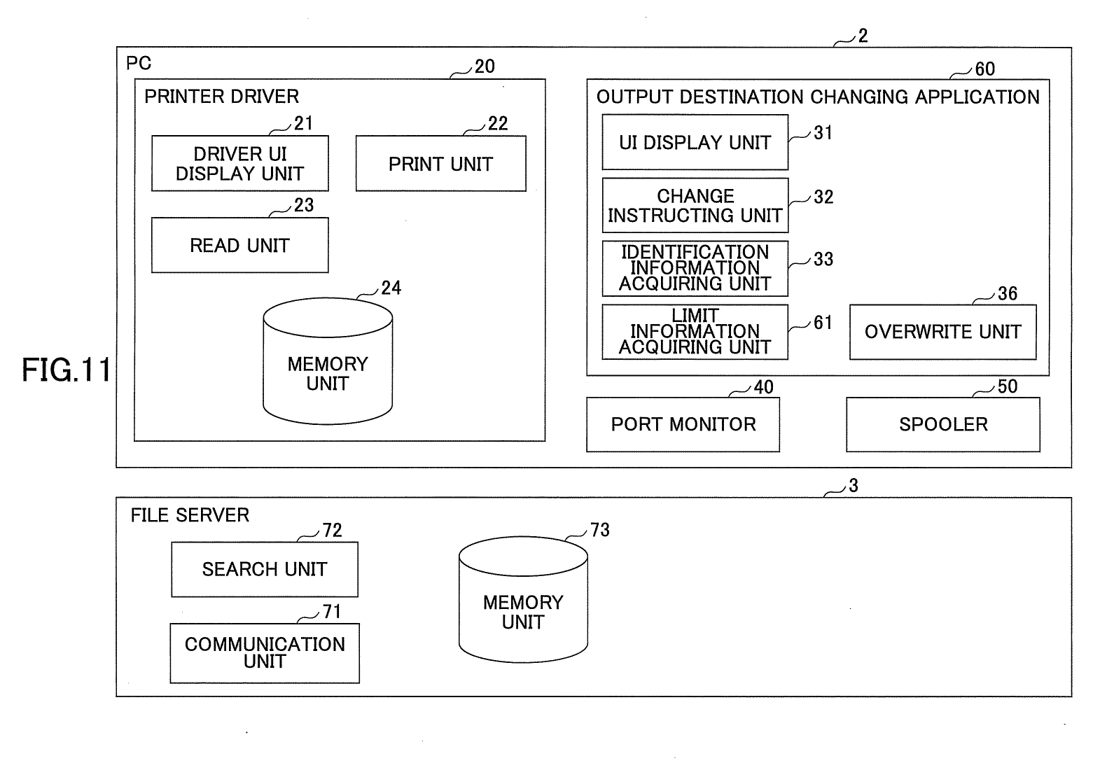

FIG. 11 is a block chart illustrating an example of functional structures of an information processing apparatus and a file server of Embodiment 2. Referring to FIG. 11, the identical numerical references are used for functions similar to those in FIG. 2, and description of these functions is omitted.

The output destination changing application includes a UI display unit 31, a change instructing unit 32, an identification information acquiring unit 33, a limit information acquiring unit 61, and an overwrite unit 36.

The limit information acquiring unit 61 acquires output destination identification information from the identification information acquiring unit 33 and requests the file server 3 to acquire limit information corresponding to the output destination identification information. The limit information acquiring unit 61 acquires the limit information requested from the file server 3 and outputs the acquired limit information to the overwrite unit 36.

The file server 3 includes a communication unit 71, a search unit 72 and a memory unit 73. The communication unit 71 receives a limit information acquiring request including output destination identification information from the information processing apparatus 2. The communication unit 71 outputs the acquired output destination identification information to the search unit 72. When the communication unit 71 acquires the limit file corresponding to the output destination identification information from the search unit 72, the communication unit 71 transmits the acquired limit file to the information processing apparatus 2.

Because the search unit 72 and the memory unit 73 have functions similar to those of the search unit 35 and the memory unit 34 illustrated in FIG. 2, description of these portions are omitted.

With this, even though the size of the limit file stored in the memory unit 73 increases, a data capacity is not specifically limited because the memory unit 73 exists on the file server 3. Further, it becomes easy to add, delete, and edit correspondence relationships between the limit files and the output destination identification information.

### <Operations>

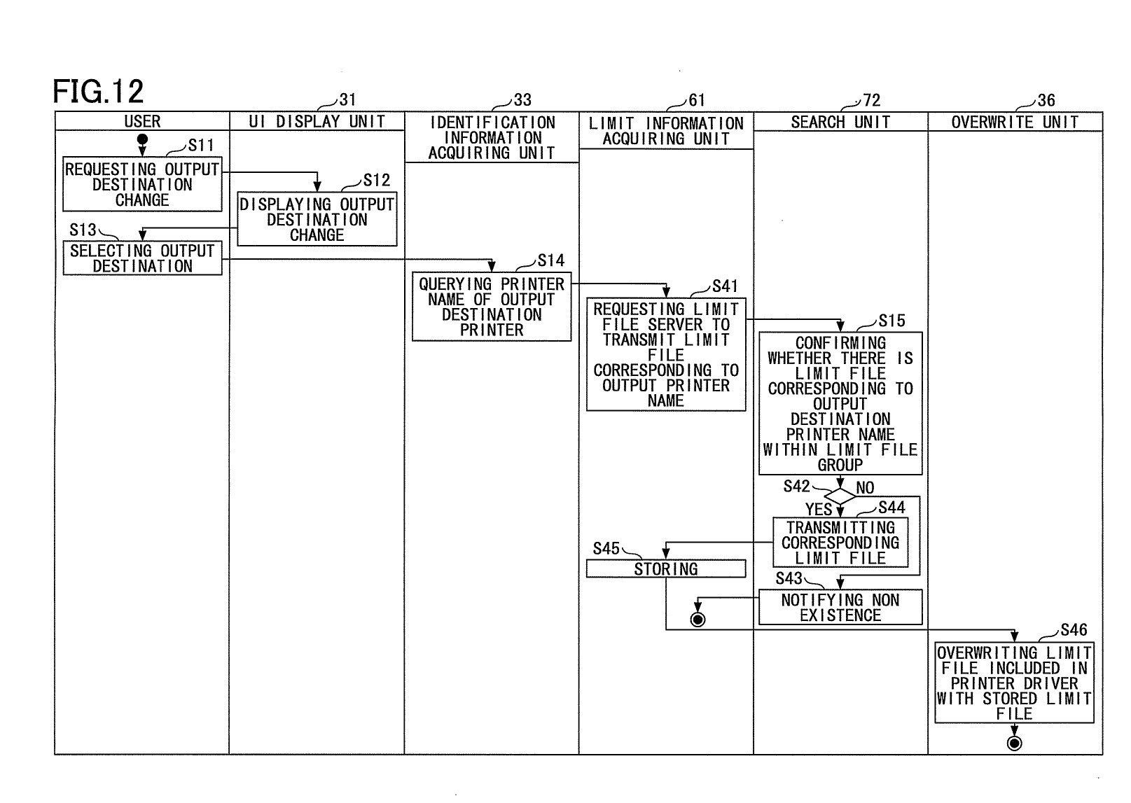

Next, the operations of the information processing system of Embodiment 2 are described. FIG. 12 is a sequence diagram illustrating an example of an overwrite process for the limit file in Embodiment 2. Referring to FIG. 12, the identical numerical references are used for processes similar to those in FIG. 7, and description of these processes is omitted.

Referring to FIG. 12, in step S41, the limit information acquiring unit 61 acquires the output destination identification information such as a printer name from the identification information acquiring unit 33. Thereafter, the limit information acquiring unit 61 requests the file server 3 to acquire the limit information corresponding to the printer name.

In step S42, the search unit 72 proceeds to step S43 when there is not a limit file corresponding to the printer name received from the information processing apparatus 2, and proceeds to step S44 when there is the limit file corresponding to the printer name.

In step S43, the search unit 72 reports non-existence of the corresponding limit file to the information processing apparatus 2 via the communication unit 71.

In step S44, the search unit 72 transmits the limit file corresponding to the printer name received from the information processing apparatus 2 via the communication unit 71.

In step S45, when the limit information acquiring unit 61 acquires the limit file from the file server 3, the limit information acquiring unit 61 stores the acquired limit file.

In step S46, the overwrite unit 36 overwrites to change the contents of the limit file in the printer driver to those of the limit file stored in the limit information acquiring unit 61.

As described, according to Embodiment 2, even though the plural pairs of the limit files and the output destination identification information are provided in the file server 3, the object of the present invention can be achieved.

The identification information acquiring unit of Embodiments 1 and 2 may acquire the output destination identification information every predetermined time period. This is because when the printer is replaced, although the IP address of the output destination does not change, the printer name may change. If the printer name changes, it is possible to properly limit printing if the limit file corresponding to the changed printer name exists.

As described, according to Embodiment 1, it is possible to carry out limit setups for plural printers using only one printer driver.

When the printers 5 and 6 become output destinations changed by the port monitor 40, the print data received from the information processing apparatuses 1 and 2 are printed by the printers 5 and 6.

It is also possible to cause a program to undertake the processes described in Embodiments 1 and 2. The information processing apparatus 1 or 2 may execute the program using a computer. Furthermore, the program may be recorded in a recording medium to enable the computer to read out the program for embodying the above-described processes in the information processing apparatus 1 or 2.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made thereto without departing from the spirit and scope of the invention.

Further, it is possible to form the information processing apparatus by combining all or parts of constitutional elements of Embodiment 1 or 2.

This patent application is based on Japanese Priority Patent Application No. 2009-213755 filed on Sep. 15, 2009, the entire contents of which are hereby incorporated herein by reference.

What is claimed is:

1. A computer-readable storage medium storing a program for causing a computer to execute a method of setting up a plurality of printers with a printer driver, the method comprising:
instructing a port monitor which outputs print data acquired from the printer driver to a preset output destination to change the output destination;
acquiring output destination identification information which identifies the changed output destination when the port monitor is instructed to change the output destination; and
searching for limit information corresponding to the acquired output destination identification information in a memory unit which stores the output destination identification information and the limit information indicative of a limit content of a printing function by associating the output destination identification information with the limit information; and
overwriting to change the limit information for the printer driver based on the searched for corresponding limit information.

2. The computer-readable storage medium according to claim 1,
wherein the overwriting changes the limit information for the printer driver based on predetermined limit information when the corresponding limit information is not searched in the searching.

3. The computer-readable storage medium according to claim 1,
wherein the acquiring acquires the output destination identification information from the preset output destination in the port monitor at every predetermined time period.

4. A computer program to be stored in the computer-readable storage medium according to claim 1.

5. An information processing apparatus in which a printer driver for a plurality of printers is installed, the information processing apparatus comprising:
a change instructing unit configured to instruct a port monitor which outputs print data acquired from the printer driver to a preset output destination to set a changed output destination in place of the preset output destination;
an identification information acquiring unit configured to acquire destination identification information which identifies the changed output destination when the port monitor is instructed by the change instructing unit to set the changed output destination; and
a memory unit configured to store the output destination identification information and the limit information indicative of a limit content of a printing function by associating the output destination identification information with the limit information;
a search unit configured to search for the limit information corresponding to the changed output destination identification information acquired by the identification information acquiring unit in the memory unit; and
an overwriting unit configured to change the limit information for the printer driver based on the corresponding limit information searched for by the search unit.

6. The information processing apparatus according to claim 5,
wherein the overwrite unit changes the limit information for the printer driver based on predetermined limit information when the corresponding limit information is not searched by the search unit.

7. The information processing apparatus according to claim 5,
wherein the identification information acquiring unit acquires the output destination identification information from the preset or changed output destination in the port monitor at every predetermined time.

8. The information processing apparatus according to claim 5, further comprising:
a display unit configured to display a printing setting screen on which display of the printing settings is limited in accordance with the limit information for the printer driver when the printing setting screen is displayed by the printer driver.

9. An information processing system comprising an information processing apparatus configured to install a printer driver for a plurality of printers and a server, the information processing apparatus and the server being connected via a network,
wherein the information processing apparatus comprising:
a change instructing unit configured to instruct a port monitor which outputs print data acquired from the printer driver to a preset output destination to set a changed output destination in place of the preset output destination;
an identification information acquiring unit configured to acquire destination identification information which identifies the changed output destination when the port monitor is instructed to set the changed output destination;
a limit information acquiring unit configured to output the output destination identification information to the server and acquire limit information indicative of a limit content of a printing function; and
an overwriting unit configured to change the limit information for the printer driver based on the limit information acquired by the limit information acquiring unit, and
the server comprising:
a memory unit configured to store the output destination identification information and the limit information by associating the output destination identification information with the limit information;
a search unit configured to acquire the output destination identification information from the information processing apparatus and search for the limit information corresponding to the acquired output destination identification information in the memory unit; and
a transmission unit configured to transmit the searched for corresponding limit information for the printer driver to the information processing apparatus.
